(19) United States
(12) Patent Application Publication
(10) Pub. No.: US 2015/0363894 A1
(43) Pub. Date: Dec. 17, 2015

(54) SYSTEM AND METHODS THEREOF FOR CONSUMER PURCHASE IDENTIFICATION FOR VALUE-ADDED TAX (VAT) RECLAIM

(71) Applicant: Vatbox, Ltd., Herzliya (IL)

(72) Inventors: Isaac SAFT, Kfar Neter (IL); Noam GUZMAN, Ramat Hasharon (IL)

(73) Assignee: VATBOX, LTD., Herzliya (IL)

(21) Appl. No.: 14/836,238

(22) Filed: Aug. 26, 2015

Related U.S. Application Data
(63) Continuation of application No. PCT/IL2014/050200, filed on Feb. 27, 2014.
(60) Provisional application No. 61/769,786, filed on Feb. 27, 2013.
(60) Provisional application No. 61/769,800, filed on Feb. 27, 2013.

(51) Int. Cl. G06Q 40/00

(52) U.S. Cl. CPC G06Q 40/123

(57) ABSTRACT

A computer implemented method and system for value added tax (VAT) reclaim processing. The method comprising receiving at least one VAT receipt from a user node; determining whether the VAT receipt is an authentic VAT receipt; determining whether the VAT receipt is eligible for a refund; and submitting the VAT receipt to a refund agency node (RAN). The system comprises a processing unit; and a memory coupled to the processing unit, the memory contains instructions that when executed by the processing unit configures the system to: receive at least one VAT receipt from a user node; determine whether the VAT receipt is an authentic VAT receipt; determine whether the VAT receipt is eligible for a refund; and submit the VAT receipt to a refund agency node (RAN).

### CROSS-REFERENCE TO RELATED APPLICATIONS

This application is a continuation of PCT Application No. PCT/IL2014/050200, filed on Feb. 27, 2014, which claims the benefit of U.S. provisional patent applications Nos. 61/769,786 filed on Feb. 27, 2013, and 61/769,800 filed on Feb. 27, 2013. The contents of the above referenced applications are hereby incorporated by reference.

### TECHNICAL FIELD

The present disclosure relates generally to computerized refunding systems and platforms and, more specifically, to computerized systems for identifying goods and services for purposes of reclaiming value-added tax (VAT) refunds.

### BACKGROUND

Laws and regulations of many countries allow foreign travelers the right for reimbursement or a refund of certain taxes, e.g., value-added tax (VAT) paid for goods or services abroad. As such laws and regulations are different from one country to another determination the actual VAT refunds that one is entitled to receive often requires that the seeker of the refund possess a vast amount of knowledge in the area of tax laws abroad.

One procedure to request a refund is to physically approach a customs official at the airport, fill a form, and file the original receipts respective of the expenses incurred during the visit. This should be performed prior to checking in or boarding to the next destination. Additionally, particularly with respect to goods purchased abroad, the procedure to request a refund may require that the payer show the unused goods to a custom official to verify that the goods being exported match the goods that the payer paid VATs on.

There are some drawbacks associated with this procedure which does not ensure that eligible travels will be refunded for paid VAT. For example, customs officials may not always attend their counter, the traveler may not know where the refund counter or do not have the time to claim the refund, or the traveler may simply be unaware of the particular refund procedures in that country. In addition, many people may be intimidated or put off from claiming their refund due to the bureaucratic hurdles that must be overcome to obtain such a refund. As such, travelers and, in particular, business travelers whose personal finances are unaffected by such VAT refunds give up on expenses that they are eligible to be reimbursed for.

VAT processing agents have certain systems for handling various aspects of a VAT reclaim process. Such systems require human intervention to resolve many of the issues of VAT receipts and determination of eligibility, and lack a full point-to-point resolution of the VAT reclaim process.

It would therefore be advantageous to provide an easy-to-use and coherent solution for reclaiming VAT taxes, particularly with respect to identifying consumer purchases to verify validity of such reclaims.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system utilized to describe the various disclosed embodiments;

FIG. 2 is a flowchart describing the analysis of ID tags of consumer purchases for VAT reclaim processing according to one embodiment;

FIG. 3 is a flowchart describing the process of matching an ID tag to a respective VAT receipt to be submitted to a refund agency according to one embodiment;

FIG. 4 is a flowchart describing the processing of a potential VAT refund according to one embodiment; and

FIG. 5 is a flowchart describing a process of authenticating and determining eligibility of a potential VAT refund according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein include a system and method for value-added tax (VAT) reclaim processing of consumer purchases. In an embodiment, the disclosed system is configured to receive unique identification (ID) tags respective of consumer purchases. Then, the ID tags are analyzed and matched to their respective VAT receipts. That is, a consumer good is uniquely identifiable by a unique ID tag that also appears in the VAT receipt. Hence, when the unique ID tag is presented it can be matched against the unique ID tag that appears on a VAT receipt. Respective of the match, the system is configured to generate refund information that can be utilized for the VAT reclaiming. According to one embodiment, the refund information is then submitted to a refund agency. The ID tags, received respective of the consumer purchase, may be scanned by, for example, a sensor affixed to a kiosk positioned at a port of exit. The scanned ID tags are uploaded to the system and then identified against a database containing tax information respective of the purchase, thereby issuing the tax refund either immediately or in a delayed manner.

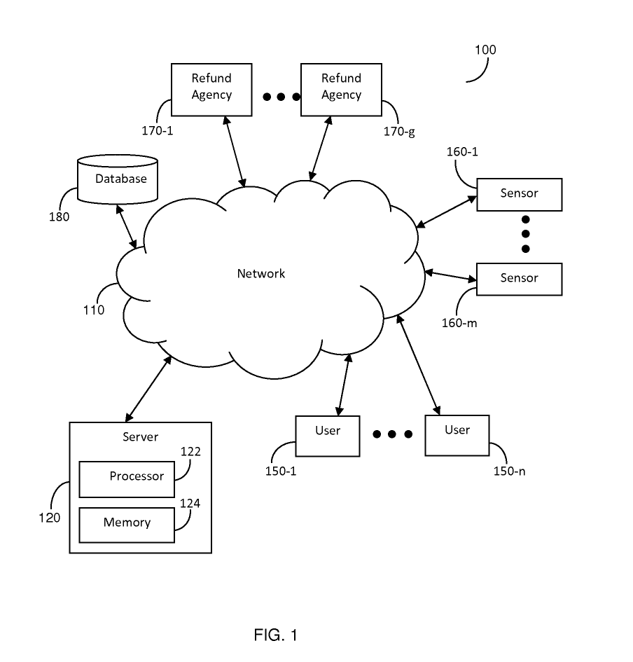

FIG. 1 is an exemplary and non-limiting schematic diagram of a system 100 for implementation of the various disclosed embodiments. A network 110 is commutatively connected to several components that comprise the system 100. The network 110 can be a local area network (LAN), a wide area network (WAN), a metro area network (MAN), the worldwide web (WWW), the Internet, implemented as wired and/or wireless networks, and any combinations thereof.

A server 120 is communicatively connected to the network 110. The system 100 includes one or more user nodes 150, i.e., 150-1 through 150-n, that are also communicatively connected to the network 110. It should be noted that the server 120 comprises a processing unit 122 and a memory 124. The processing unit 122 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 122 may be coupled to the memory 124. In an embodiment, the memory 124 contains instructions that when executed by the processing unit 122 results in the performance of the methods and processes described herein below. Specifically, the processing unit 122 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 122 to perform the various functions described herein.

In certain exemplary embodiments, the system 100 includes optional components, such as refund agency nodes (RANs) 170-1 through 170-g. Each RAN 170 may be also communicatively connected to the server 120 through the network 110. An official operating a RAN 170, for example 170-1, may be, for example, but not limited to, a tax authority, an accountant, and the like. Each one of the nodes, including the user nodes 150 and the RANs 170, is a computing device such as, but not limited to a personal computer (PC), a notebook computer, a cellular phone, a smartphone, a tablet device, and the like. In an embodiment, a RAN 170 may be a legacy accounting or taxation server.

The system 100 may also include a database 180 for maintaining information to be used for a VAT refund. The database 180 is communicatively connected to the server 120. The system 100 further includes one or more sensors 160-1 through 160-m that are communicatively connected to the server 120 through the network 110. Such sensors 160 may be, for example, but not limited to, a barcode scanner, a camera, a microphone, etc. A sensor 160, for example 160-1, is used to scan ID tags of consumer purchases. Scanning may include optical, infrared (IR), wireless, and other methods enabling the recognition of an ID tag. According to one embodiment, the sensor 160-1 may be affixed to a kiosk positioned at a port of exit. Furthermore, such a kiosk may provide a notification upon a successful scanning. In another embodiment, a sensor 160 may be connected to or integrated in a point of sale terminal at a merchant or retailer. In yet another embodiment, a sensor 160 may be an apparatus connected to or an application installed in a user node 150. This would allow scanning of ID tags directly from the user node.

The server 120 is configured to receive, as an input, scanned ID tags of consumer purchases for which a VAT refund can be potentially claimed. The server 120 is further configured to receive receipts from a user node 150 such as, for example, the user node 150-1.

A receipt may provide an acknowledgment that the total payment and/or the VAT payment that has been made. In an embodiment, a user takes a picture or scans the receipt using the user node 150. Then, an upload process is initiated by the node 150. Such a process includes opening a connection (preferably a secured connection) with the server 120 over the network 110, providing user information (e.g., name, residency, a bank account or credit account information to place the refund, contact information, and so on), and uploading the one or more copies of the receipts. The process can be realized by a software application (mobile or native application or ‘app’) installed in the node 150, an add-on installed in a web browser running the node 150, or through the web browser.

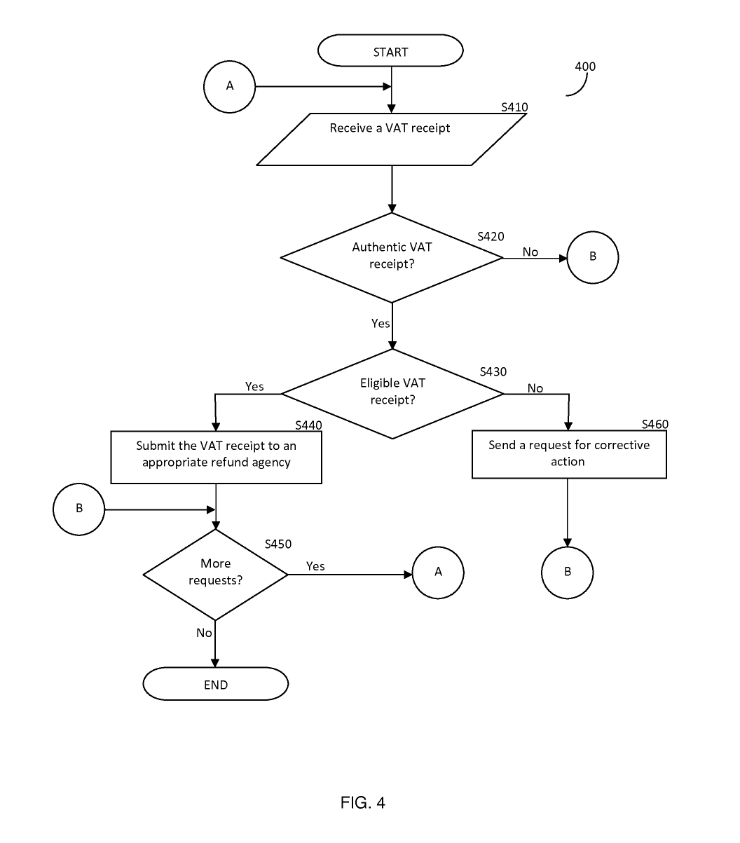

The server 120 is further configured to perform authenticity and eligibility analysis for each VAT receipt received to identify a potential VAT refund process. The operation of identifying the potential VAT refund process may be performed as further discussed in the U.S. Provisional Patent Application No. 61/769,786 filed on Feb. 27, 2013, the contents of which are incorporated herein by reference. An exemplary and non-limiting implementation of the authenticity and eligibility analysis is discussed with respect of FIG. 4 hereinbelow.

The server 120 is configured to analyze the received ID tag in order to find a matching VAT receipt. This can be performed since, when a purchase occurs, the payer obtains the unique ID tag, where the unique ID tag is also associated with the VAT receipt. Analysis of the received ID tag may include recognition of one or more parameters that are relevant to VAT refunds. Such parameters may include category of purchase (e.g., goods or services), type of goods purchased (e.g., electronics, toys, clothing, food, hotel accommodations, restaurant bills, and so on), price, and registrations of goods and/or services in official agency records.

The server 120 uses the ID tag and the matched VAT receipt to identify information to be used for VAT reclaim. As an example, the server 120 is configured to identify registrations of goods within official registrations. According to this example, when buying an electronic device, for example a computer, the computer has the unique ID tag affixed thereto, typically at the time of sale. When the payer pays for the computer, he or she also receives the unique ID tag as part of the purchase.

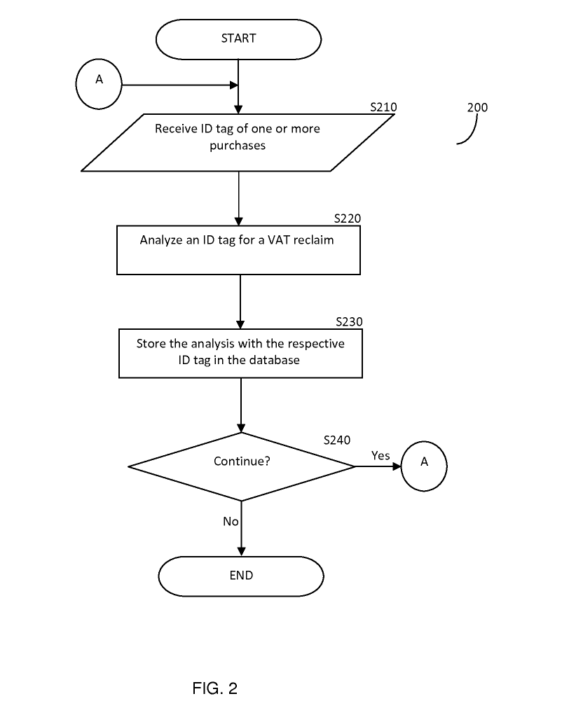

According to one embodiment, the ID tag, the VAT receipt, and the results of the analysis resulting from the ID tag and VAT information (see more details below with respect to FIG. 2), are then stored as metadata in the database 180 for further use. According to another embodiment, the server 120 submits the VAT receipt and the respective metadata to, for example, a RAN 170 for the VAT reclaim process. It should be noted that the issuing of the VAT refund may be either immediate or delayed.

FIG. 2 is an exemplary and non-limiting flowchart 200 describing the analysis of ID tags of consumer goods or services for VAT reclaim processing according to one embodiment. The method may be performed by the server 120.

In S210, one or more ID tags respective of one or more consumer goods or services are received. According to one embodiment, the ID tags are scanned by sensors 160. In S220, each received ID tag is analyzed to identify information, such as but not limited to, point of sale, type of good, VAT assessed, and more, to be used for the VAT reclaim processing. This analysis may be based on the results of scanning the tag using sensors 160, and may further involve retrieving additional information from a database based on information stored in the barcode. In S230, the server 120 stores the ID and the respective analysis as metadata in the database 180 tag for further use. In S240, it is checked whether there are additional ID tags and if so, execution continues with S210; otherwise, execution terminates.

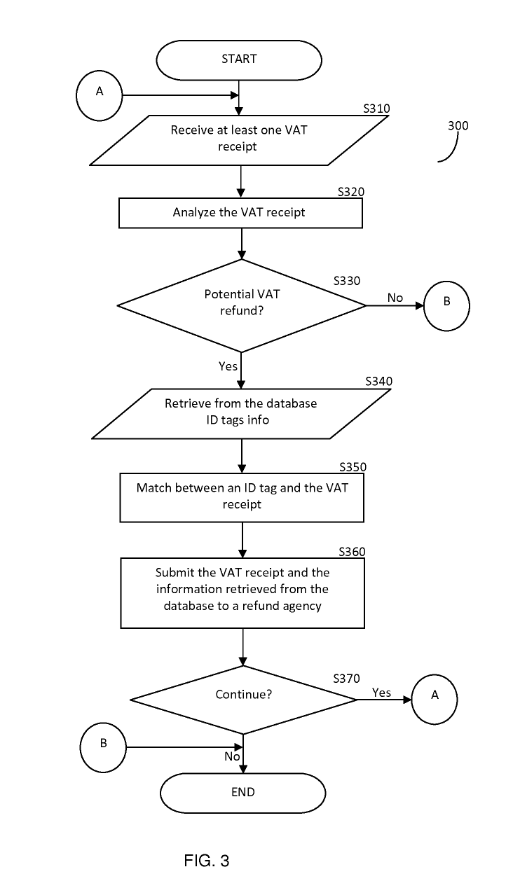

FIG. 3 depicts an exemplary and non-limiting flowchart 300 describing the VAT reclaim process of consumer purchases having an ID tag affixed thereto according to one embodiment. The method may be performed by the server 120.

In S310, at least one VAT receipt is received from a node such as, for example, the user node 150-1. In S320, the VAT receipt is analyzed to determine if the receipt and/or the user are authorized and eligible for the refund, for example, as discussed with respect to FIG. 4 hereinbelow. In S330, it is checked whether a potential VAT refund is identified and, if so, execution continues with S340; otherwise, execution terminates.

In S340, at least one ID tag and its respective metadata is retrieved from the database 180. The retrieval is performed using at least the unique ID designated in the receipt for the purchase. In S350, matching between the VAT receipt and an ID tag is performed. This matching may include, but is not limited to, analyzing the information recorded in the receipt such as, for example, the country where the VAT reclaim is issued, parameters related to the purchased items, the user information stored in the database including, but not limited to, the residency of the entity to which the VAT receipt was issued, and so on.

In S360, the VAT receipt and metadata retrieved at S340 are sent to a RAN 170, for example the RAN 170-1. In S370, it is checked whether there are additional VAT receipts and if so, execution continues with S310; otherwise, execution terminates.

The following is a non-limiting example for the process discussed above. The process begins at the purchase of an item that is assigned a unique ID. Typically, the unique ID is a tag affixed to the item (or its package) and also is entered onto the receipt which is then stored electronically. A unique ID may also include a voucher, coupon, business card, or other service-related identifier. A traveler who wishes to reclaim a VAT can scan the ID tag of the item, for example, at a kiosk in an airport. Alternatively or collectively, the traveler can scan or otherwise upload a copy of the receipt. Then, matching is performed on the item having the unique ID and the stored receipt, which also contains the details of the person who purchased the item. Upon identification of a match, the refund request together with the collected information can be sent to a RAN.

FIG. 4 depicts an exemplary and non-limiting flowchart 400 of a method for VAT reclaim processing according to one embodiment. The method may be performed by the server 120.

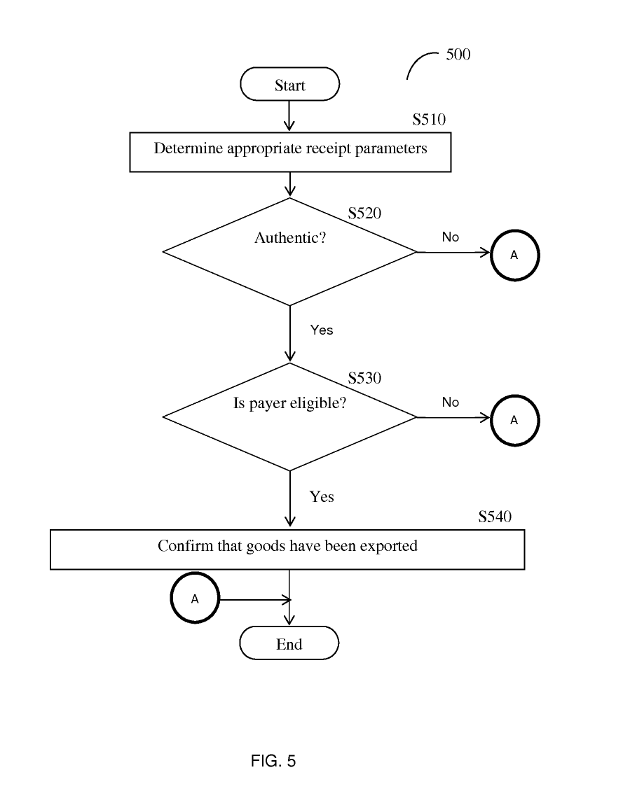

In S410, at least one VAT receipt is received. According to one embodiment, the VAT receipt may be provided by, for example, a user node 150 through, e.g., a web user interface, a dedicated agent installed thereon, and the like. In S420 it is checked whether the VAT receipt is an authentic VAT receipt and, if so, execution continues with S430; otherwise, execution continues with S450. The authentication check may be made respective of information stored in the database 180 by analyzing data collected from the receipt with respect of information stored in the database 180. Authentication is discussed in more detail below with respect to FIG. 5.

In S430, it is checked whether the VAT receipt is an eligible VAT receipt and if so, execution continues with S440; otherwise, execution continues with S460. According to one embodiment, an analysis of one or more parameters in the VAT receipt which are required for a VAT refund is performed. Examples for such parameters include, for example, payer's name, payer's address, name of entity being paid, tax identification of entity being paid, receipt number, description of item being paid for, date, currency, and other data appearing on a VAT receipt. Lack of the appropriate or necessary information, as well as illegibility of such information on the VAT receipt, may result in a determination that the VAT is ineligible for a refund as the receipt stands. In addition, one or more missing, unclear or otherwise unacceptable parameters and acting thereupon may be identified, for example, based on information in the database 180. Eligibility checking is discussed in more detail below with respect to FIG. 5.

In S440, the VAT receipt is submitted to an appropriate or otherwise preferred RAN 170. The preference may be determined based on effectiveness in getting refunds, location, and so on. In S450, it is checked whether there are additional requests and if so, execution continues with S410; otherwise, execution terminates.

In S460, a request to edit the VAT receipt may be sent to, for example, the user node 150 that provided the VAT reclaim, thereby providing an opportunity to correct and resubmit the illegible receipt. Execution continues thereafter with S450.

As an exemplary and non-limiting example of submission of a VAT receipt according to an embodiment, a user who is a traveler returning from Greece to Canada scans a receipt provided upon purchase of a souvenir and uploads the receipt to a server (e.g., server 120) over the WWW (e.g., network 110) via a smartphone (e.g., user node 150-1). Upon receiving the VAT receipt, the server performs authentication to ensure that the receipt is an authentic original. In this example, the receipt indicates the name and address of an existing business that is noted in a database (e.g., database 180), as participating in providing VAT refunds. The server compares the name and address from the receipt with the name and address data stored in the database and determines that the receipt is authentic. Next, the server verifies that the receipt demonstrates a purchase that is eligible for a VAT refund by checking the price and type of item purchased, as well as the status of the customer (e.g., tourist or business traveler). Upon verifying that the consumer bought a qualified item worth above a predefined eligibility cost threshold (e.g., $30), the server submits the VAT receipt to an appropriate RAN. In this case, the server identifies a RAN associated with a refund agency that is located in Greece to be the destination for the submission. Upon confirming that no additional requests have been made, execution terminates.

As another exemplary and non-limiting example, a user who is a business traveler provides a receipt to a server (e.g., server 120) received pursuant to a purchase of hotel accommodations over the WWW (e.g., network 110) via a computer (e.g., user node 150-1). In the example, the receipt originally indicated a price, but the receipt has been smudged, thereby making the price illegible. The receipt also indicates the name and address of an existing business that is noted as participating in providing VAT refunds in a database (e.g., database 180). The server compares the name and address from the receipt with the name and address data stored in the database and determines that the receipt is authentic. The server proceeds to initiate eligibility checking by comparing parameters related to price and type of purchase on the receipt to parameters stored in the database. In this case, the price is illegible. Consequently, the server determines that the receipt, as is, is not eligible for a VAT refund. The server, acting in accordance with instructions provided in a database (e.g., database 180), sends an error message to the computer (user node 150-1) noting that the price is missing or illegible. The user is then given an opportunity to resubmit the receipt.

FIG. 5 shows a flowchart 500 describing a process of authenticating and determining eligibility of a potential VAT refund according to an embodiment. The method may be performed by the server 120.

In S510, in response to receiving a potential VAT receipt, a server (e.g., server 120) recognizes appropriate receipt parameters respective of the potential VAT receipt. Recognition of parameters may be performed by the server via, for example, a computer-based word recognition program or via scanning of a barcode on the receipt. In a further embodiment, parameters may be noted as absent or illegible. In an embodiment, one or more of the parameters may be retrieved according to the ID tag. If parameters noted as absent or illegible are required for authentication or for eligibility checking, execution will terminate after S520 or after S530, respectively.

Such parameters may be parameters related to authentication including, but not limited to, information related to the business that sold the goods or service (e.g., the business's name, address, e-mail address, telephone number, and so on), and data related to the receipt itself (e.g., boldness of words on receipt). Such parameters may also be parameters related to eligibility including, but not limited to, payment information (e.g., payer's name, payer's address, name of entity being paid, tax identification of entity being paid, receipt number, date, currency, and other data appearing on a VAT receipt), information related to the goods or service (e.g., price, type of goods or service, description of item being paid for, and so on), and information demonstrating exportation of goods (e.g., shipping data).

In S520, it is determined based on the appropriate receipt parameters whether the potential VAT receipt is authentic. If so, execution continues with S530; otherwise, execution terminates. A potential VAT receipt may be determined to be unauthentic if it is a forgery or a duplicate. Determination of authenticity may be performed by comparing the recognized authentication parameters to information stored in a database (e.g., database 180), or by verifying the recognized authentication parameters with a RAN node (e.g., RAN 170-1). In another embodiment, if the potential VAT receipt is determined to be unauthentic, a message indicating the lack of authenticity may be generated and sent to, e.g., the user, the business, or a refund agency.

In S530, it is determined based on the appropriate receipt parameters whether the payer is eligible for a VAT refund. Determination of eligibility may be based on considerations such as: the price of the goods or services, the home country of the payer, status of the payer (e.g., business traveler, tourist, and the like), type of goods or services purchased, and so on. For example, a payer may be eligible for a VAT refund only upon purchasing $30 or more worth of goods or services from a business located in a country that is not the payer's home country. As another example, a VAT refund for hotel accommodations may only be available if the payer is a business traveler (as opposed to a tourist). Eligibility may be determined by comparing the recognized parameters with threshold eligibility parameters stored in a database (e.g., database 180). In a further embodiment, if a payer is ineligible for a VAT refund, a message indicating that the payer is ineligible may be generated and sent to the user, the business, or a refund agency via the entity's respective node. This message may further contain a request for corrective action, prompting the user or other entity to resubmit a receipt or provide additional information.

In S540, a user may be required to confirm that one or more goods has actually been exported when the refund is based on the purchase of goods. This confirmation may be completed by, e.g., the user providing a shipping receipt demonstrating that the goods have been shipped directly to another country. In a further embodiment, if a user does not successfully confirm that goods have been exported, a message indicating that the goods have not actually been exported may be generated and sent to the user, the business, or a refund agency via the entity's respective node. This message may further contain a request for corrective action.

It should be appreciated by one of ordinary skill in the art that an identification (ID) tag is not strictly limited to a tag physically attached goods. Rather, identification tags may include any identifying marker such as, but not limited to, vouchers, coupons, business cards, portions thereof, and so on. Therefore, the refund process disclosed herein can be applicable to reclaim VAT paid for services as well.

The certain embodiment disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A person skilled-in-the-art will readily note that other embodiments of the disclosure may be achieved without departing from the scope of the disclosed embodiments. All such embodiments are included herein. The scope of the disclosed embodiments should be limited solely by the claims thereto.

What is claimed is:

1. A computer implemented method for value added tax (VAT) reclaim processing, comprising:
receiving at least one VAT receipt from a user node;
determining whether the VAT receipt is an authentic VAT receipt;
determining whether the VAT receipt is eligible for a refund; and
submitting the VAT receipt to a refund agency node (RAN).

2. The computer implemented method of claim 1, wherein the VAT receipt is determined to be authentic respective of information stored in a database by analyzing data collected from the VAT receipt with respect of information stored in the database.

3. The computer implemented method of claim 1, wherein the VAT receipt is determined to be eligible for a refund respective of an analysis of one or more parameters in the VAT receipt which are required for a VAT refund.

4. The computer implemented method of claim 3, wherein the one or more parameters include at least one of: a payer's name, a payer's address, a name of an entity being paid, a tax identification of the entity being paid, a receipt number, a description of item being paid for, a date, and a currency.

5. The computer implemented method of claim 4, wherein the VAT receipt is determined to be ineligible for a refund respective of at least one of: a lack of necessary information, and illegibility of the necessary information on the VAT receipt.

6. The computer implemented method of claim 5, further comprising:
upon a determination that the VAT receipt is ineligible for a refund, sending a request to edit the VAT receipt to the user node.

7. A non-transitory computer readable medium having stored thereon instructions for causing one or more processing units to execute the method according to claim 1.

8. A system for value added tax (VAT) reclaim processing, the system comprising:
a processing unit; and
a memory coupled to the processing unit, the memory contains instructions that when executed by the processing unit configures the system to:
receive at least one VAT receipt from a user node;
determine whether the VAT receipt is an authentic VAT receipt;
determine whether the VAT receipt is eligible for a refund; and
submit the VAT receipt to a refund agency node (RAN).

9. The system of claim 8, wherein the VAT receipt is determined to be authentic respective of information stored in a database by analyzing data collected from the VAT receipt with respect of information stored in the database.

10. The system of claim 8, wherein the VAT receipt is determined to be eligible for a refund respective of an analysis of one or more parameters in the VAT receipt which are required for a VAT refund.

11. The system of claim 10, wherein the one or more parameters include at least one of: a payer's name, a payer's address, a name of an entity being paid, a tax identification of the entity being paid, a receipt number, a description of item being paid for, a date, and a currency.

12. The system of claim 11, wherein the VAT receipt is determined to be ineligible for a refund respective of at least one of: a lack of necessary information, and illegibility of the necessary information on the VAT receipt.

13. The system of claim 12, further configured to:
upon a determination that the VAT receipt is ineligible for a refund, send a request to edit the VAT receipt to the user node.
